(19) United States
(12) Patent Application Publication
(10) Pub. No.: US 2017/0260946 A1
(43) Pub. Date: Sep. 14, 2017

(54) FUEL RAIL FOR GASOLINE DIRECT-INJECTION ENGINE

(71) Applicant: USUI CO., LTD., Shimizu-cho, Sunto-gun, Shizuoka (JP)

(72) Inventors: Masaru Suzuki, Shimizu-cho (JP); Shuji Suzuki, Shimizu-cho (JP); Koichi Hayashi, Shimizu-cho (JP)

(21) Appl. No.: 15/521,763

(22) PCT Filed: Nov. 5, 2015
(86) PCT No.: PCT/JP2015/081166

§ 371 Date: Apr. 25, 2017

(30) Foreign Application Priority Data
Nov. 10, 2014 (JP) 2014-228467

(51) Int. Cl. F02M 55/02; F02M 37/00

(52) U.S. Cl. CPC F02M 55/025; F02M 37/0017

(57) ABSTRACT

Provided is a fuel rail for a gasoline direct-injection engine, characterized in that a branch connector is attached to a main pipe through a recessed connection member, the recessed connection member is secured to the main pipe by brazing or welding, the branch connector is recess-projection fitted to the recessed connection member and is detachably fastened thereto by a thread fastening mechanism or by a bolt fastening mechanism, and an O-ring provided between the recessed connection member and the branch connector is tightened by an axial force created by fastening of the branch connector to thereby create a seal between the recessed connection member and the branch connector; and a hardness of the branch connector is set to be lower than that of the branch pipe facing the branch connector.

### BACKGROUND

1. Field of the Invention

The present invention relates to a fuel rail for supplying a high-pressure fuel, which is supplied from a fuel booster pump of an electronic fuel injection-type automobile engine or the like, through a fuel injector (an injection nozzle) directly injecting the fuel into an engine cylinder, and more particularly, the invention relates to a fuel rail for a gasoline direct-injection engine having a structure in which a branch connector (a connection nipple or an inlet) is attached to a main pipe.

2. Description of the Related Art

Known are conventional fuel rails for gasoline direct-injection engines of this type including: a fuel rail including a main pipe and a branch connector (a connection nipple or an inlet) which are integrally formed by a forging method, and a fuel rail having a structure in which a branch connector is connected to a main pipe by welding or brazing. Among these fuel rails, a typical fuel rail for a gasoline direct-injection engine having a branch connector secured to a main pipe by welding or brazing has the following structure in which, for example as illustrated in FIG. 7, a through-hole 21-2 communicating with a flow passage 21-1 of a main pipe 21, which is formed of a pipe made of steel or stainless steel, is formed in a circumferential wall portion in an axial direction of the main pipe 21; a branch connector 22 having a communicating hole 22-1 communicating with the through-hole 21-2 is secured by brazing; a pressing seat surface 23-2 formed by a connection head portion 23-1 of a branch pipe 23 for supplying a fuel to an injection nozzle (not illustrated) of each cylinder is brought into abutment on a pressure receiving seat surface 22-2, which is opened outward and formed at a tip end of the communicating hole 22-1 of the branch connector, and is thereby joined to the pressure receiving seat surface 22-2; and a fastening nut 24 which is incorporated in the branch pipe 23 in advance is screwed to the branch connector 22 to be tightened and connected along with pressing of a portion under the connection head portion 23-1. As a structure similar to this structure, Japanese Patent Laid-Open No. 2006-233964 discloses a common rail for a diesel engine. This common rail for a diesel engine has a structure in which a branch connector for fastening a branch pipe for supplying a fuel to an injection nozzle of each cylinder with a nut is secured by friction welding to a common rail body made of a thick steel pipe,.

However, in the conventional fuel rail for the gasoline direct-injection engine having a structure in which the branch connector 22 is directly brazed or welded to the main pipe 21, which is formed of a pipe made of steel or stainless steel, a sealed section formed between the pressure receiving seat surface 22-2 provided on the branch connector 22 and the pressing seat surface 23-2 formed by the connection head portion 23-1 provided on the branch pipe 23 is sealed with a difference in hardness between the branch connector 22 and the branch pipe 23. Accordingly, for example, when the hardness of the branch connector 22 is lower (softer) than that of the branch pipe 23, the pressure receiving seat surface 22-2 provided on the branch connector 22 is plastically deformed due to aging. Therefore, part replacement needs to be performed to prevent leakage of the sealed section due to aging. However, in the case of the conventional structure, since the branch connector 22 is secured to the main pipe 21, when the branch connector 22 is replaced, a set of the fuel rail needs to be replaced in a state where the branch connector 22 is secured to the main pipe 21. Accordingly, it takes a lot of labor and time to replace the part and it is necessary to arrange a set of a fuel rail as a part to be replaced, which causes a problem that the cost required for part replacement is high. Further, when the hardness of the branch pipe 23 is lower (softer) than that of the branch connector 22, it is necessary to arrange a set of a branch pipe as a part to be replaced in the case of part replacement due to aging, which also causes the problem that the cost required for part replacement is high, as in the case described above.

### SUMMARY

The present invention has been made to solve the problems inherent in the conventional fuel rails, and an object of the present invention is to provide a fuel rail for a gasoline direct-injection engine that facilitates part replacement, in particular, replacement of a branch connector.

A fuel rail for a gasoline direct-injection engine according to the present invention has a structure in which only a branch connector can be easily replaced, as summarized below. According to a first aspect of the invention, provided is a fuel rail for a gasoline direct-injection engine, the fuel rail including a main pipe provided with a branch connector, the main pipe being formed of a pipe made of steel or stainless steel, the branch connector having a pressure receiving seat surface opened outward to connect a branch pipe, the fuel rail being characterized in that: the fuel rail is configured such that the branch connector is attached to the main pipe through a recessed connection member having a communicating hole which communicates with a through-hole formed in the main pipe, the recessed connection member is secured to the main pipe by brazing or welding, a lower end portion of the branch connector is recess-projection fitted to the recessed connection member and is detachably fastened thereto by a thread fastening mechanism, and an O-ring provided between the recessed connection member and the branch connector is tightened by an axial force created by fastening of the branch connector to thereby create a seal between the recessed connection member and the branch connector; and a hardness of the branch connector is set to be lower than that of the branch pipe facing the branch connector.

According to a second aspect of the invention, provided is a fuel rail for a gasoline direct-injection engine, the fuel rail including a main pipe provided with a branch connector, the main pipe being formed of a pipe made of steel or stainless steel, the branch connector having a pressure receiving seat surface opened outward to connect a branch pipe, the fuel rail being characterized in that: the fuel rail is configured such that the branch connector is attached to the main pipe through a recessed connection member having a communicating hole which communicates with a through-hole formed in the main pipe, the recessed connection member is secured to the main pipe by brazing or welding, a lower end portion of the branch connector is recess-projection fitted to the recessed connection member and is detachably fastened thereto by a bolt fastening mechanism, and an O-ring provided between the recessed connection member and the branch connector is tightened by an axial force created by fastening of the branch connector to thereby create a seal between the recessed connection member and the branch connector; and a hardness of the branch connector is set to be lower than that of the branch pipe facing the branch connector.

Further, each of the recessed connection member of the thread fastening mechanism and the recessed connection member of the bolt fastening mechanism may be a ring-shaped (annular) recessed connection member that is attached to surround an outer circumferential portion of the main pipe.

A fuel rail for a gasoline direct-injection engine in accordance with the present invention employs a way of attaching a branch connector through a recessed connection member using a thread fastening mechanism, or a recessed connection member using a bolt fastening mechanism, as a mechanism for attaching the branch connector to a main pipe, and also employs an O-ring sealing as a sealing mechanism. The fuel rail has a structure in which an O-ring provided between the recessed connection member and the branch connector is tightened by an axial force created by the tightening of the branch connector that is screwed and fastened to the recessed connection member, or by an axial force created by the tightening of the branch connector that is bolt-fastened to the recessed connection member, to thereby create a seal. Thus, the branch connector is detachably fastened to the recessed connection member. Further, the hardness of the branch connector is set to be lower than that of the branch pipe facing the branch connector. With this structure, only a partial replacement of the branch connector portion, i.e., only the replacement of the branch connector and the O-ring, is required in the case of part replacement due to aging. Consequently, the part replacement work can be facilitated and the cost required for part replacement can be drastically reduced.

### BRIEF DESCRIPTION OF DRAWINGS

FIG. 1 is a partial longitudinal sectional view illustrating a first embodiment of a fuel rail for a gasoline direct-injection engine according to the present invention.

FIG. 2 is a partial longitudinal sectional view illustrating a second embodiment of the fuel rail for the gasoline direct-injection engine according to the present invention.

FIG. 3 is a partial cross-sectional view illustrating a third embodiment of the fuel rail for the gasoline direct-injection engine according to the present invention.

FIG. 4 is a partial cross-sectional view illustrating a fourth embodiment of the fuel rail for the gasoline direct-injection engine according to the present invention.

FIG. 5 is a partial cross-sectional view illustrating a fifth embodiment of the fuel rail for the gasoline direct-injection engine according to the present invention.

FIG. 6 is a partial cross-sectional view illustrating a sixth embodiment of the fuel rail for the gasoline direct-injection engine according to the present invention.

FIG. 7 is a partial longitudinal sectional view illustrating an example of a conventional fuel rail for a gasoline direct-injection engine.

### DETAILED DESCRIPTION

A fuel rail for a gasoline direct-injection engine of a first embodiment illustrated in FIG. 1 has the following structure. That is, a recessed connection member 3 having at a central portion thereof a communicating hole 3-1 communicating with a through-hole 1-2, which is pierced in a circumferential wall portion in an axial direction of a main pipe 1 that is formed of a pipe made of steel or stainless steel and has a flow passage 1-1 formed therein, is joined to the through-hole 1-2 by brazing or welding; a lower end portion of a branch connector 2 is recess-projection fitted to the recessed connection member 3 and is detachably fastened thereto by a thread fastening mechanism; and an O-ring 4 provided between the recessed connection member 3 and the branch connector 2 is tightened by an axial force created by the thread fastening of the branch connector 2 to thereby create a seal between the recessed connection member 3 and the branch connector 2.

In this regard, to facilitate part replacement due to aging as mentioned above, the hardness of the branch connector 2 is set to be lower than that of the recessed connection member 3 and a pressing seat surface 6-2 formed by a connection head portion 6-1 of a branch pipe 6. A recess of the recessed connection member 3 is formed of a small-diameter hole portion 3-2 and a large-diameter hole portion 3-3, and an internal thread 3-3a is formed at an inner circumference of the large-diameter hole portion 3-3. On the other hand, the branch connector 2 having a pressure receiving seat surface 2-2 which is opened outward and formed at a tip end of a communicating hole 2-1 communicating with the through-hole 1-2 of the main pipe 1 is provided with an external thread 2-5 which is formed at an upper portion of the branch connector and is screwed to a fastening nut 7, and is also provided with a small-diameter cylinder portion 2-3 and a large-diameter cylinder portion 2-4 which correspond to the small-diameter hole portion 3-2 and the large-diameter hole portion 3-3, respectively, of the recessed connection member 3 in order to allow a lower end portion of the branch connector to be recess-projection fitted to the recessed connection member 3. Further, the large-diameter cylinder portion 2-4 is provided with an external thread 2-4a to be screwed to the internal thread 3-3a of the recessed connection member 3. In addition, an annular groove 2-6 for incorporating the O-ring 4 for sealing is formed at a boundary portion between the small-diameter cylinder portion 2-3 and the large-diameter cylinder portion 2-4. Reference numeral 5 denotes a brazed portion.

In a manufacturing process for the fuel rail for the gasoline direct-injection engine illustrated in FIG. 1, the recessed connection member 3 is brazed to the through-hole 1-2, which is pierced in the circumferential wall portion in the axial direction of the main pipe 1, for example, in a brazing process. In this case, the recessed connection member 3 is disposed to correspond to the through-hole 1-2 and is joined to the outer circumferential surface of the main pipe 1 by brazing. In this state, the branch connector 2 is thread-fastened to the recessed connection member 3, to thereby detachably connect the branch connector 2 to the recessed connection member 3. At this time, the branch connector 2 is screwed and joined to the recessed connection member 3 in a state where the O-ring 4 is preliminarily fitted onto the annular groove 2-6 at the lower end portion of the branch connector 2. At this point, the O-ring 4 provided between the recessed connection member 3 and the branch connector 2 is tightened by the axial force created by the thread fastening of the branch connector 2, to thereby create a seal between the recessed connection member 3 and the branch connector 2. When the branch connector 2 is joined to the recessed connection member 3, the pressing seat surface 6-2 formed by the connection head portion 6-1 of the branch pipe 6 for supplying a fuel to an injection nozzle (not illustrated) of each cylinder is brought into abutment on the pressure receiving seat surface 2-2, which is opened outward and formed at the tip end of the communicating hole 2-1 of the branch connector, and is thereby joined to the pressure receiving seat surface 2-2. Then, the fastening nut 7, which is incorporated in the branch pipe 6 in advance, is screwed to the branch connector 2 and is thereby fastened and connected along with pressing of a portion under the connection head portion 6-1.

In the fuel rail for the gasoline direct-injection engine illustrated in FIG. 1 having the structure as described above, when the pressure receiving seat surface 2-2 of the branch connector 2 is plastically deformed due to aging and needs to be replaced, the old branch connector 2 that is thread-fastened to the recessed connection member 3 is dismounted from the recessed connection member 3 and is replaced by a new branch connector 2. In this case, the O-ring 4 is replaced as needed. Thus, in the case of part replacement, only a partial replacement of the branch connector 2 that is thread-fastened to the recessed connection member 3 is required, so that the part replacement work can be performed simply and rapidly and the cost required for part replacement can be drastically reduced. Further, since the O-ring 4 provided between the recessed connection member 3 and the branch connector 2 is tightened by the axial force created by the thread fastening of the branch connector 2, to thereby create a seal between the recessed connection member 3 and the branch connector 2, the stability and reliability of the seal are ensured.

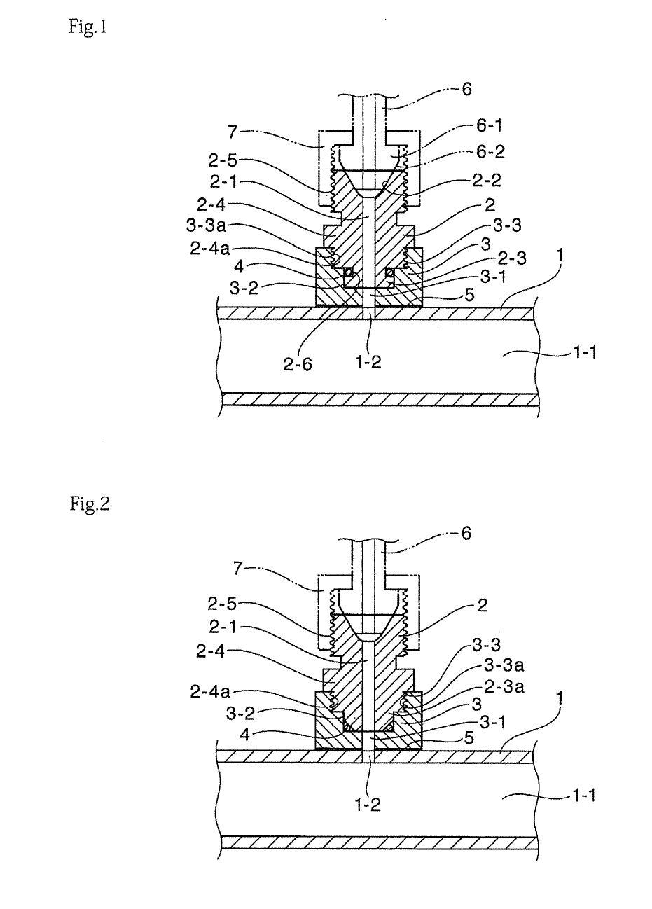

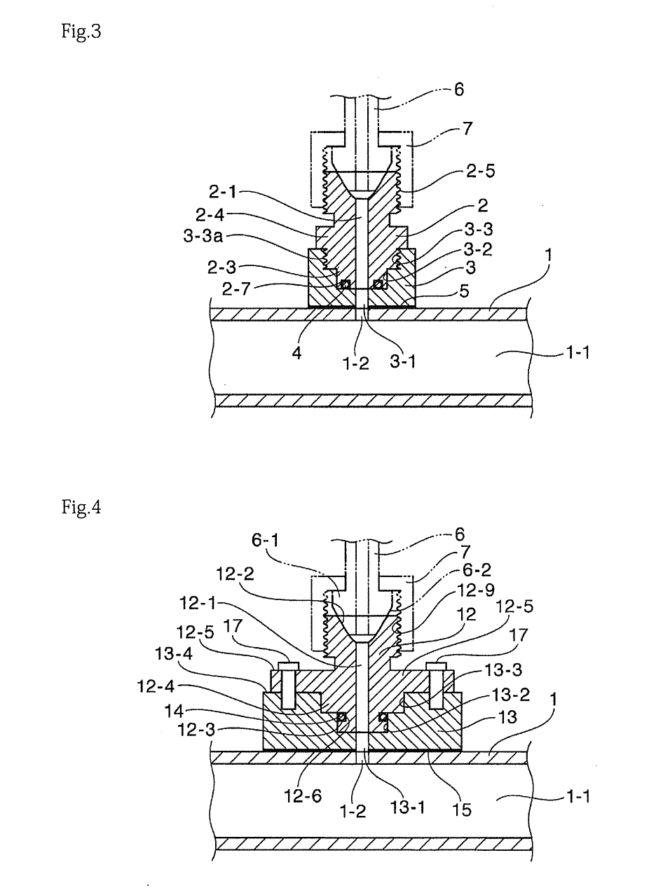

A fuel rail for a gasoline direct-injection engine of a second embodiment illustrated in FIG. 2 and a fuel rail for a gasoline direct-injection engine of a third embodiment illustrated in FIG. 3 have a structure similar to that of the fuel rail for the gasoline direct-injection engine illustrated in FIG. 1, except that only the structure of a section sealed by the O-ring 4 is changed. Among these fuel rails, the fuel rail for the gasoline direct-injection engine of the second embodiment illustrated in FIG. 2 has the structure, in which the lower end portion of the branch connector 2 to be recess-projection fitted to the small-diameter hole portion 3-2 of the recessed connection member 3 that is joined to the main pipe 1 by brazing or welding is formed as a small-diameter cylinder portion 2-3a which is formed into a frustoconical shape, and the O-ring 4 is provided in a gap between the small-diameter cylinder portion 2-3a and the small-diameter hole portion 3-2 of the recessed connection member 3. Accordingly, also in the fuel rail for the gasoline direct-injection engine of the second embodiment illustrated in FIG. 2, as in the fuel rail for the gasoline direct-injection engine illustrated in FIG. 1, the O-ring 4 is tightened by the axial force created by the thread fastening of the branch connector 2, to thereby create a seal between the branch connector 2 and the recessed connection member 3, so that the stability and reliability of the seal are ensured.

The fuel rail for the gasoline direct-injection engine of the third embodiment illustrated in FIG. 3 has the structure, in which the O-ring 4 is attached to an annular groove 2-7 which is formed at a lower end face of the small-diameter cylinder portion 2-3 of the branch connector 2 to be recess-projection fitted to the small-diameter hole portion 3-2 of the recessed connection member 3 that is joined to the main pipe 1 by brazing or welding, and the O-ring 4 is tightened by the axial force created by the thread fastening of the branch connector 2, to thereby create a seal between the branch connector 2 and the recessed connection member 3. Also in this seal structure, the stability and reliability of the seal are ensured, as in the fuel rails for gasoline direct-injection engines illustrated in FIGS. 1 and 2.

A fuel rail for a gasoline direct-injection engine of a fourth embodiment illustrated in FIG. 4 has the following structure. That is, a recessed connection member 13 having at a central portion thereof a communicating hole 13-1 communicating with the through-hole 1-2, which is pierced in the circumferential wall portion in the axial direction of the main pipe 1 that is formed of a pipe made of steel or stainless steel and has the flow passage 1-1 formed therein, is joined to the through-hole 1-2 by brazing or welding; a lower end portion of a branch connector 12 is recess-projection fitted to the recessed connection member 13 and is detachably fastened thereto by a bolt fastening mechanism; and an O-ring 14 provided between the recessed connection member 13 and the branch connector 12 is tightened by the axial force created by the fastening of the branch connector 12 to thereby create a seal between the recessed connection member 13 and the branch connector 12.

In this regard, as in the structures described above, the recessed connection member 13 is provided with a recess which is formed at a central portion thereof and is formed of a small-diameter hole portion 13-2 and a large-diameter hole portion 13-3, and is also provided with a bolt fastening surface 13-4 of the branch connector 12 which is formed around the opening of the recess. On the other hand, the branch connector 12 having a pressure receiving seat surface 12-2 which is opened outward and formed at a tip end of a communicating hole 12-1 communicating with the through-hole 1-2 of the main pipe 1 is provided with an external thread 12-9 which is formed at an upper portion of the branch connector and is screwed to the fastening nut 7, and is also provided with a small-diameter cylinder portion 12-3 and a large-diameter cylinder portion 12-4 which correspond to the small-diameter hole portion 13-2 and the large-diameter hole portion 13-3, respectively, of the recessed connection member 13 in order to allow the lower end portion of the branch connector to be recess-projection fitted to the recessed connection member 13. Further, a bolt fastening flange 12-5 which faces the bolt fastening surface 13-4 is horizontally provided to protrude above the large-diameter cylinder portion 12-4. In addition, an annular groove 12-6 for incorporating the O-ring 14 for sealing is formed at a boundary portion between the small-diameter cylinder portion 12-3 and the large-diameter cylinder portion 12-4. Reference numeral 15 denotes a brazed portion.

In a manufacturing process for the fuel rail for the gasoline direct-injection engine illustrated in FIG. 4, the recessed connection member 13 is brazed to the through-hole 1-2, which is pierced in the circumferential wall portion in the axial direction of the main pipe 1, for example, in a brazing process, in the same manner as the manufacturing process described above. After that, the branch connector 12 is bolt-fastened to the recessed connection member 13, which is joined to the outer circumferential surface of the main pipe 1 by brazing, thereby detachably connecting the branch connector 12 to the recessed connection member 13. In this case, the branch connector 12 is recess-projection fitted to the recessed connection member 13 in a state where the O-ring 14 is preliminarily fitted onto the annular groove 12-6 at the lower end portion of the branch connector 12, and the bolt fastening flange portion 12-5 is tightened with a fastening bolt 17, to thereby join the branch connector 12 to the recessed connection member 13. At this point, the O-ring 14 fitted onto the annular groove 12-6 is tightened by the axial force created by the tightening of the fastening bolt 17, to thereby create a seal between the recessed connection member 13 and the branch connector 12. When the branch connector 12 is joined to the recessed connection member 13, as in the structures described above, the pressing seat surface 6-2 formed by the connection head portion 6-1 of the branch pipe 6 for supplying a fuel to an injection nozzle (not illustrated) of each cylinder is brought into abutment on the pressure receiving seat surface 12-2 which is opened outward and formed at the tip end of the communicating hole 12-1 of the branch connector, and is thereby joined to the pressure receiving seat surface 12-2. Then, the fastening nut 7, which is incorporated in the branch pipe 6 in advance, is screwed to the branch connector 12 and is thereby fastened and connected along with pressing of a portion under the connection head portion 6-1. Also in this structure, in consideration of facilitating part replacement due to aging, the hardness of the branch connector 12 is set to be lower than that of the recessed connection member 13 and the pressing seat surface 6-2 formed by the connection head portion 6-1 of the branch pipe 6.

In the fuel rail for the gasoline direct-injection engine illustrated in FIG. 4 having the structure as described above, when the pressure receiving seat surface 12-2 of the branch connector 12 is plastically deformed due to aging and needs to be replaced, the old branch connector 12 that is bolt-fastened to the recessed connection member 13 is dismounted from the recessed connection member 13 and is replaced by a new branch connector 12. Thus, also in this embodiment, in the case of part replacement, only a partial replacement of the branch connector 12 that is bolt-fastened to the recessed connection member 13 is required, so that the part replacement work can be performed simply and rapidly and the cost required for part replacement can be drastically reduced. Further, since the O-ring 14 provided between the recessed connection member 13 and the branch connector 12 is tightened by the axial force created by the tightening of the fastening bolt 17, to thereby create a seal between the recessed connection member 13 and the branch connector 12, the stability and reliability of the seal are ensured.

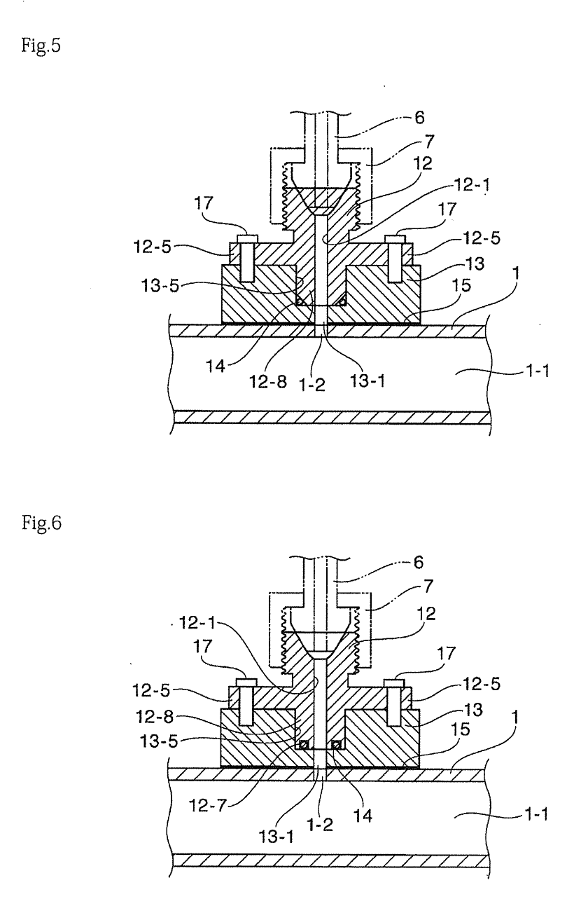

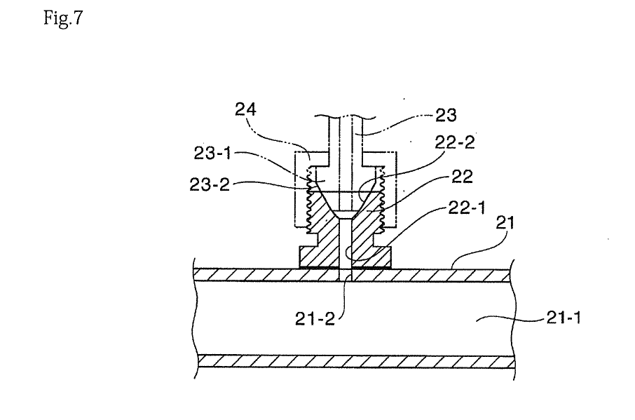

A fuel rail for a gasoline direct-injection engine of a fifth embodiment illustrated in FIG. 5 and a fuel rail for a gasoline direct-injection engine of a sixth embodiment illustrated in FIG. 6 has the structure of a section where the branch connector 12 and the recessed connection member 13 are recess-projection fitted to each other is simplified and the structure of a section sealed by the O-ring 14 is changed to a structure similar to the structures illustrated in FIGS. 2 and 3, respectively. Among these fuel rails, the fuel rail for the gasoline direct-injection engine of the fifth embodiment illustrated in FIG. 5 has the structure, in which a lower end portion of a protrusion of the branch connector 12 corresponding to a straight hole 13-5, which is formed at a central portion of the recessed connection member 13 that is joined to the main pipe 1 by brazing, is formed as a straight cylinder 12-8 that is formed into a frustoconical shape, and the O-ring 14 is provided in a gap between the straight cylinder 12-8 and the straight hole 13-5 of the recessed connection member 13. Accordingly, also in the fuel rail for the gasoline direct-injection engine of the fifth embodiment illustrated in FIG. 5, as in the fuel rail for the gasoline direct-injection engine illustrated in FIG. 4, the O-ring 14 is tightened by the axial force created by the fastening of the branch connector 12, to thereby create a seal between the branch connector 12 and the recessed connection member 13, so that the stability and reliability of the seal are ensured.

Further, the fuel rail for the gasoline direct-injection engine of the sixth embodiment illustrated in FIG. 6 has the structure, in which the O-ring 14 is attached to an annular groove 12-7, which is formed at a lower end face of the straight cylinder 12-8 of the branch connector 12 to be recess-projection fitted to the straight hole 13-5 of the recessed connection member 13 that is joined to the main pipe 1 by brazing, and the O-ring 14 provided between the recessed connection member 13 and the branch connector 12 is tightened by the axial force created by the tightening of the fastening bolt 17, to thereby create a seal between the recessed connection member 13 and the branch connector 12. Also in this seal structure, the stability and reliability of the seal are ensured, as in the fuel rails for gasoline direct-injection engines illustrated in FIGS. 4 and 5.

In this regard, each of the recessed connection member 13 of the thread fastening mechanism and the recessed connection member 13 of the bolt fastening mechanism may be a ring-shaped (annular) recessed connection member (not illustrated) of a type of attaching the recessed connection member to surround an outer circumferential portion of the main pipe 1.

### REFERENCE SIGNS LIST

1 main pipe
1-1 flow passage
1-2 through-hole
2-2, 12-2 pressure receiving seat surface
2, 12 branch connector
2-1, 3-1, 12-1, 13-1 communicating hole
2-3, 2-3a, 12-3 small-diameter cylinder portion
2-4, 12-4 large-diameter cylinder portion
2-4a, 2-5, 12-9 external thread
2-6, 2-7, 12-6, 12-7 annular groove
3, 13 recessed connection member
3-2, 13-2 small-diameter hole portion
3-3, 13-3 large-diameter hole portion
3-3a internal thread
4, 14 O-ring
5, 15 brazed portion
6 branch pipe
6-1 connection head portion
6-2 pressing seat surface
7 fastening nut
12-5 bolt fastening flange
12-8 straight cylinder
13-4 bolt fastening surface
13-5 straight hole
17 fastening bolt

1. A fuel rail for a gasoline direct-injection engine, the fuel rail comprising a main pipe provided with a branch connector, the main pipe being formed of a steel or stainless steel pipe, the branch connector having a pressure receiving seat surface opened outward to connect a branch pipe, the fuel rail being characterized in that:
the branch connector is attached to the main pipe through a recessed connection member having a communicating hole which communicates with a through-hole formed in the main pipe,
the recessed connection member is secured to the main pipe by brazing or welding,
a lower end portion of the branch connector is recess-projection fitted to the recessed connection member and is detachably fastened thereto by a thread fastening mechanism, and
an O-ring provided between the recessed connection member and the branch connector is tightened by an axial force created by fastening of the branch connector to thereby create a seal between the recessed connection member and the branch connector; and
a hardness of the branch connector is set to be lower than that of the branch pipe facing the branch connector.

2. A fuel rail for a gasoline direct-injection engine, the fuel rail comprising a main pipe provided with a branch connector, the main pipe being formed of a steel or stainless steel pipe, the branch connector having a pressure receiving seat surface opened outward to connect a branch pipe, the fuel rail being characterized in that:
the branch connector is attached to the main pipe through a recessed connection member having a communicating hole which communicates with a through-hole formed in the main pipe,
the recessed connection member is secured to the main pipe by brazing or welding,
a lower end portion of the branch connector is recess-projection fitted to the recessed connection member and is detachably fastened thereto by a bolt fastening mechanism, and
an O-ring provided between the recessed connection member and the branch connector is tightened by an axial force created by fastening of the branch connector, to thereby create a seal between the recessed connection member and the branch connector; and
a hardness of the branch connector is set to be lower than that of the branch pipe facing the branch connector.

3. The fuel rail for the gasoline direct-injection engine according to claim 1, wherein of the recessed connection member of the thread fastening mechanism is a ring-shaped annular recessed connection member that is attached to surround an outer circumferential portion of the main pipe.

4. The fuel rail for the gasoline direct-injection engine according to claim 2, wherein each of the recessed connection member of the bolt fastening mechanism is a ring-shaped annular recessed connection member that is attached to surround an outer circumferential portion of the main pipe.
